(19) United States
(12) Patent Application Publication
(10) Pub. No.: US 2022/0224002 A1
(43) Pub. Date: Jul. 14, 2022

(54) ANTENNA MODULE AND VEHICLE COMPRISING SAME

(71) Applicant: EMW CO., LTD., Incheon (KR)

(72) Inventors: Won Mo SEONG, Gyeonggi-do (KR); Ui Sheon KIM, Gyeonggi-do (KR); Se Ah CHOI, Seoul (KR); Gi Ho KIM, Gyeonggi-do (KR); Hyun Seob JEONG, Seoul (KR)

(21) Appl. No.: 17/614,714

(22) PCT Filed: May 15, 2020
(86) PCT No.: PCT/KR2020/006401

§ 371 Date: Nov. 29, 2021

(30) Foreign Application Priority Data
May 28, 2019 (KR) 10-2019-0062576

(51) Int. Cl. H01Q 1/46; H01Q 9/40; H01Q 1/32

(52) U.S. Cl. CPC H01Q 1/46; H01Q 1/32; H01Q 9/40

(57) ABSTRACT

An antenna module according to an embodiment of the present disclosure includes a ground area formed in a rectangular shape on at least a portion of a main board, a pair of power feeding units formed at two of edge portions of the rectangular ground area while being spaced apart from each other, and a pair of monopole antennas electrically connected to the power feeding units, respectively, and disposed on the ground area. An antenna module is provided in a vehicle and transmits/receives a communication signal to provide a communication service.

### CROSS REFERENCE TO RELATED APPLICATIONS AND CLAIM OF PRIORITY

This application claims benefit under 35 U.S.C. 119(e), 120, 121, or 365(c), and is a National Stage entry from International Application No. PCT/KR2020/006401, filed May 15, 2020, which claims priority to the benefit of Korean Patent Application No. 10-2019-0062576 filed in the Korean Intellectual Property Office on May 28, 2019, the entire contents of which are incorporated herein by reference.

### BACKGROUND

### 1. Technical Field

The present invention relates to an antenna module and a vehicle comprising the same and, more particularly, to an antenna module provided in a vehicle and transmtting/receiving a communication signal to provide a communication service, and a vehicle comprising the same.

### 2. Background Art

Efforts to improve data transmission speed have continued as the amount of data usage through communication networks has rapidly increased. For example, with the development of the long term evolution (LTE) communication standard, the frequency band has been expanded to improve the data transmission speed. Recently, the 5G communication standard has been developed to further expand the data transmission speed and processing capacity, but the communication system for implementing the communication standard is still insufficient.

Recently, a new concept of vehicle wireless Internet service that combines wireless communication and vehicles according to such an LTE or 5G communication standard has been developed. There is suggested a ‘telematics’ technology that provides user-centered services such as telex, videotex, and facsimile, by exchanging information using a communication system inside and outside a vehicle or between vehicles based on the wireless voice and data communication and the location information system using satellites.

In order to implement such telematics, the antenna module provided in a vehicle needs to support not only the LTE communication standard, but also the 5G communication standard. To support such communication standard, it is necessary to develop a technology for expanding the frequency band of the antenna module.

### SUMMARY

Accordingly, the technical task of the present invention has been conceived in this regard, and the present invention can implement stable telematics by providing an antenna module having improved isolation degree and equipped with the 5G communication standard as well as the LTE communication standard through frequency band expansion.

According to an embodiment of the present invention, there is provided an antenna module that includes a ground area formed in a rectangular shape on at least a portion of a main board; a pair of power feeding units formed at two of edge portions of the rectangular ground area while being spaced apart from each other; and a pair of monopole antennas electrically connected to the power feeding units, respectively, and disposed on the ground area.

The antenna module may further include a first shunt device branching from a feeding line connected to the monopole antenna from the power feeding unit.

The antenna module may include a second shunt device branching from the feeding line while being connected in parallel with the first shunt device.

The power feeding units may be formed at both ends of one short side of the rectangular ground area while facing each other.

One of the pair of monopole antennas may be disposed along a long side of the ground area, and a remaining monopole antenna may be disposed along a short side of the ground area.

One of the pair of monopole antennas may be disposed along a long side of the ground area, and a remaining monopole antenna may be disposed along another long side of the ground area.

The antenna module may further include a global navigation satellite system (GNSS) antenna or a Wi-Fi antenna disposed along a long side of the ground area in adjacent to the monopole antenna disposed along the long side of the ground area.

The power feeding units may be formed at both ends of one long side of the rectangular ground area while facing each other.

One of the pair of monopole antennas may be disposed along a long side of the ground area, and a remaining monopole antenna may be disposed along a short side of the ground area.

One of the pair of monopole antennas may be disposed along one short side of the ground area, and a remaining monopole antenna may be disposed along another short side of the ground area.

The antenna module may further include a global navigation satellite system (GNSS) antenna or a Wi-Fi antenna disposed along a long side of the ground area between the pair of monopole antennas.

According to another embodiment of the present invention, there is provided a vehicle including an antenna module.

According to an embodiment of the present invention, it is possible to implement stable telematics by providing an antenna module capable of supporting 5G communication standards as well as LTE communication standards through frequency band extension and improvement of isolation degree.

Effects of the present invention may not be limited to the above, and other effects will be clearly understandable to those having ordinary skill in the art from the appended claims.

### BRIEF DESCRIPTION OF THE DRAWINGS

The summary described above as well as the detailed description of the preferred embodiments of the present application to be described below may be better understood when read in conjunction with the accompanying drawings. For the purpose of illustrating the present invention, preferred embodiments are shown in the drawings. However it should be understood that the present application is not limited to the arrangements and means shown in the drawings.

FIG. 1 is a perspective view of an antenna module according to an embodiment of the present invention.

FIGS. 2 to 4 are reference diagrams illustrating a modified example of an antenna module according to an embodiment of the present invention.

FIGS. 5 and 6 are circuit diagrams of an antenna module according to an embodiment of the present invention.

FIG. 7 is a reference diagram illustrating a monopole antenna of an antenna module according to an embodiment of the present invention.

### DETAILED DESCRIPTION

Hereinafter, various embodiments of the present invention will be described in detail with reference to the accompanying drawings. However, the features of the embodiment disclosed in the present specification will be more clearly understood from the accompanying drawings and should not be limited by the accompanying drawings. It will be readily apparent to those skilled in the art that the scope of the present invention is not limited to the scope of the accompanying drawings.

In describing the embodiments of the present invention, the same names and reference numerals are used for the components having the same functions, and it is stated in advance that they are not substantially the same as the components of the related art.

Terms used in this disclosure are used to describe specified examples of the present invention and are not intended to limit the scope of the present invention. The terms of a singular form may include plural forms unless otherwise specified. In the present invention, terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Hereinafter, an antenna module and a vehicle including the same will be described in detail with reference to accompanying drawings. In the following description, the same reference numerals will be assigned to the same or corresponding elements and redundant description thereof will be omitted.

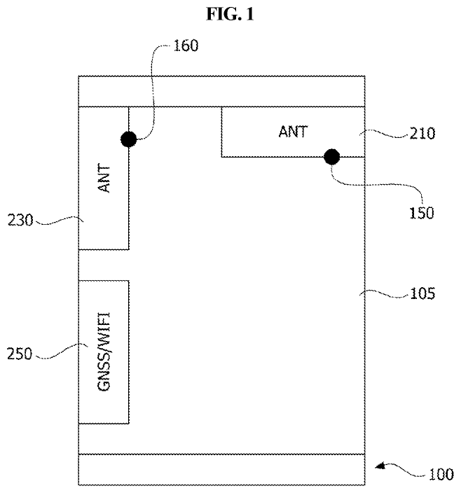

FIG. 1 relates to an antenna module according to an embodiment of the present invention, wherein the antenna module according to the embodiment is installed in a vehicle to wirelessly transmit/receive data. The antenna module may be disposed inside the vehicle or may be in the form of a mobile terminal carried by a driver positioned in the vehicle, and the antenna module may be installed on the vehicle roof of the vehicle.

The antenna module according to an embodiment of the present invention may include a main board 100, ground areas 110 and 120, power feeding units 150 and 160, and monopole antennas 210 and 230.

The main board 100 may be mounted inside an antenna device (not shown) including an antenna module. The main board 100 may be a hard type printed circuit board (PCB) or a flexible printed circuit board (FPCB).

In this case, a plurality of electronic components (electronic function group) may be mounted on the main board 100. In detail, a connector for connecting the main board 100 and another external electronic device (not shown), a GNSS antenna for checking location information of a vehicle, a WIFI antenna, and the like may be mounted on the main board 100.

The main board 100 may be configured to include a ground area 105 and a non-ground area (not shown). In addition, the ground area 105 may be formed on a portion of the main board 100, and a non-ground area (not shown) may be formed on the remaining portion of the main board 100 except for the ground area 105.

The ground area 105 may be formed in at least a portion of the main board 100 in a rectangular shape having a long side and a short side. The ground area 105 provides a ground voltage inside the antenna module.

The power feeding units 150 and 160 may be formed to be spaced apart from each other at edge portions of the ground area 105. In the present embodiment, an edge portion may mean a certain area formed around four edges of the rectangular ground area 105, and the feeding units 150 and 160 may be formed as a pair at two of the edge portions of the ground area 105 while being spaced apart from each other.

The power feeding units 150 and 160 feed current to a pair of monopole antennas 210 and 230 to be described later. The feeding units 150 and 160 may be connected to a coaxial cable (not shown) to supply power to the monopole antennas 210 and 230.

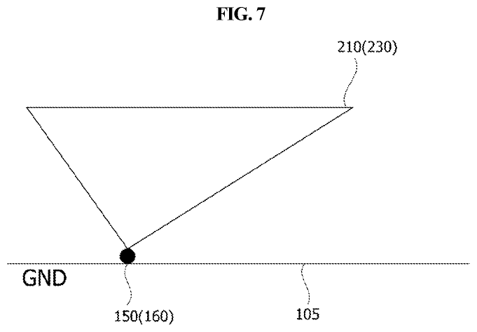

The monopole antennas 210 and 230 may be formed as a pair and may be electrically connected to the pair of power feeding units 150 and 160, respectively. The monopole antennas 210 and 230 may be vertically connected to the power feeding units 150 and 160 to protrude from the ground area 105. In detail, the monopole antennas 210 and 230 may protrude to have a predetermined height and a predetermined area, and may be formed in various shapes such as a triangle and a square (refer to FIG. 7).

In this case, the monopole antennas 210 and 230 may be formed to be asymmetrical with respect to the power feeding units 150 and 160. FIG. 7 is a reference view illustrating the shape of the monopole antennas 210 and 230 according to an embodiment of the present invention. Referring to FIG. 7, each of the monopole antennas 210 and 230 having a constant area may be asymmetrically formed such that the areas on the left and right are different with respect to each of the power feeding units 150 and 160. In this case, the sizes of the left and right areas of each of the monopole antennas 210 and 230 may be formed differently depending on the overall size (area and height) of the antenna module and the lowest frequency to be implemented.

For example, when the height of the antenna module is lower than 1/10 of the lowest frequency wavelength and the frequency band to be implemented is the 0.7 GHz band, the ratio between the left and right areas of the monopole antennas 210 and 230 may be set as 2.5:1.

In the present embodiment, it has been described that each of the monopole antennas 210 and 230 is formed in an inverted triangle and the left and right areas are different based on the vertices of the triangle connected to each of the power feeding units 150 and 160, but the present invention is not limited thereto. The present invention may include a case where each of the monopole antennas 210 and 230 of various shapes has different areas on the left and right with respect to the power feeding unit 150 or 160.

According to the asymmetric shapes of the monopole antennas 210 and 230, the frequency band of the antenna is expanded, thereby improving antenna performance. In detail, when the monopole antennas 210 and 230 are asymmetrically formed, one side of the antenna is long and another side is short, where the long side of the antenna operates in the low frequency band and the short side operates in the middle and high frequency bands, thereby expanding the frequency band of the antenna. That is, by forming the monopole antennas 210 and 230 asymmetrically, the frequency band may be expanded while maintaining the height in the antenna module having a limited size.

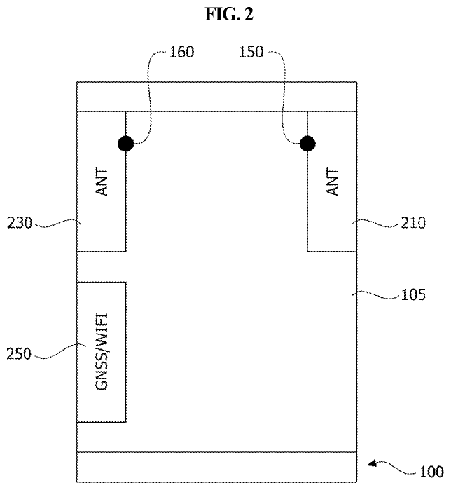

FIGS. 1 to 4 are reference views illustrating the arrangement structure of the monopole antennas 210 and 230 of an antenna module according to an embodiment of the present invention. Referring to FIGS. 1 to 4, the pair of power feeding units 150 and 160 may be formed to face each other at both end portions of one short side of the rectangular ground area 105 (refer to FIGS. 1 and 2). That is, the pair of power feeding units 150 and 160 may be formed on both edge portions of the short side of the rectangular ground area 105 while being spaced apart from each other.

In this case, among the pair of monopole antennas 210 and 230, one monopole antenna 230 may be disposed along the long side of the ground area 105, and the other monopole antenna 210 may be disposed along the short side of the ground area 105. That is, the pair of monopole antennas 210 and 230 may be disposed to be orthogonal to each other.

In addition, among the pair of monopole antennas 210 and 230, one monopole antenna 230 may be disposed along one long side of the ground area 105, and the other monopole antenna 210 may be disposed along another long side of the ground area 105.

In addition, the antenna module according to the present invention may further include a global navigation satellite system (GNSS) antenna 250 or a Wi-Fi antenna 250. The GNSS antenna 250 transmits/receives data to confirm vehicle location information using a satellite navigation system, and the WIFI antenna 250 supports short-range wireless transmission/reception. In this case, the WIFI antenna 250 may be a multi input and multi output (MIMO) antenna. The GNSS antenna 250 or the WIFI antenna 250 may be disposed along the long side of the ground area 105. In detail, the GNSS antenna 250 or the WIFI antenna 250 may be disposed adjacent to the monopole antenna 230 disposed along the long side of the ground area 105. In this case, the GNSS antenna 250 and the WIFI antenna 250 may be modularized and disposed together.

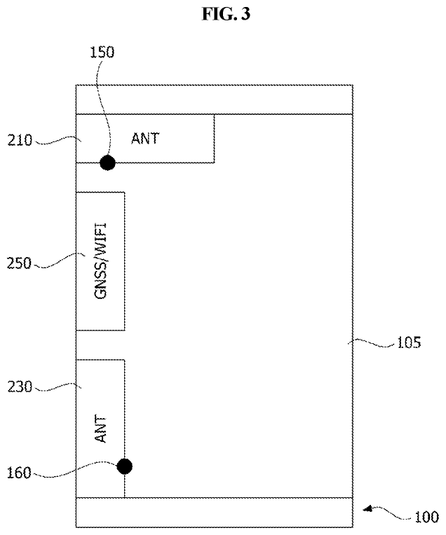

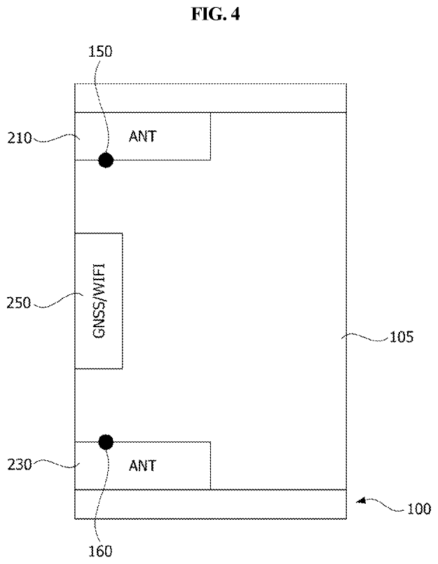

Meanwhile, the pair of power feeding units 150 and 160 may be formed at both end portions of one long side of the rectangular ground area 105 to face each other (refer to FIGS. 3 and 4). That is, the pair of power feeding units 150 and 160 may be formed at both edge portions of the rectangular ground area 105 while being spaced apart from each other.

In this case, one monopole antenna 230 of the pair of monopole antennas 210 and 230 may be disposed along the long side of the ground area 105, and the other monopole antenna 210 may be disposed along the short side of the ground area 105. That is, the pair of monopole antennas 210 and 230 may be disposed to be orthogonal to each other.

Also, among the pair of monopole antennas 210 and 230, one monopole antenna 230 may be disposed along one short side of the ground area 105, and the other monopole antenna 210 may be disposed along another short side of the ground area 105.

In this case, the GNSS antenna 250 or the WIFI antenna 250 may be disposed along the long side of the ground area 105. In detail, the GNSS antenna 250 or the WIFI antenna 250 may be disposed to be adjacent to the monopole antenna 230 disposed along the long side of the ground area 105, and may be disposed between the pair of monopole antennas 210 and 230.

In order to support multiple frequency bands according to the 5G communication standard as well as the LTE communication standard, it is necessary to cover the frequency band while maintaining the degree of isolation above a certain level. In the present invention, the power feeding units 150 and 160 may be formed on the edge portions of the ground area 105 to be spaced apart from each other, and thus, the monopole antennas 210 and 230 may be disposed along the long or short side, respectively, thereby achieving such effects. That is, the monopole antennas 210 and 230 may be disposed along the long or short side of the ground area 105 to vertically or horizontally form the polarization between the two monopole antennas 210 and 230, so that it is possible to cover the frequency band while maintaining the isolation degree.

For the purpose of high isolation degree, the power feeding units 150 and 160 are preferably spaced apart from each other as far as possible. However, when the feeding line is long, current loss, etc. may occur, thereby degrading the antenna performance. Thus, by arranging the power feeding units 150 and 160 to be spaced apart from each other at both end portions of either the long or short side of the ground area 105, the isolation degree may be improved while maintaining the antenna performance.

Accordingly, a strong current flow may be formed by the pair of monopole antennas 210 and 230 based on the power feeding units 150 and 160 and a current path in the form of a loop is formed as a whole, so that it is possible to expand the frequency band and maintain a high level of isolation.

In this case, the monopole antennas 210 and 230 may be multi-input and multi-output (MIMO) antennas in order to improve the transmission speed.

The antenna module according to an embodiment of the present invention may form a bandwidth of about 600 MHz to 1 GHz in a low frequency band, form a bandwidth of about 1.4 GHz to 2.7 GHz in a middle frequency band, and form a bandwidth of about 3.3 GHz to 6.0 GHz in a high frequency band, thereby improving the bandwidth and increasing the data transmission speed.

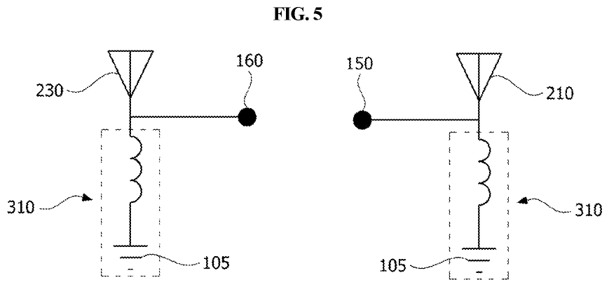

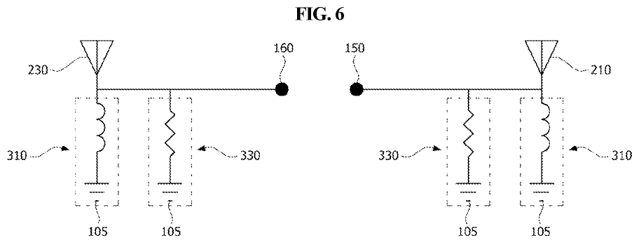

Meanwhile, referring to FIGS. 5 and 6, the antenna module according to the present invention may include a first shunt device 310. The first shunt device 310 may be branched from a feeding line connected from the power feeding units 150 and 160 to the monopole antennas 210 and 230 to be formed on each of the pair of monopole antennas 210 and 230. The first shunt device 310 may be shunt inductance shun L that is grounded to the ground, and improves the isolation of the antenna module. When the length of the ground area 105 is smaller than the wavelength of the lowest frequency band to be implemented, the first shunt device 310 is implemented as parallel inductance in the matching circuit of the antenna for impedance matching of the low frequency band. By applying the parallel inductance as described above, the impedance matching of the low frequency band may be improved and the gain of the low frequency band may be improved, thereby expanding the operating bandwidth of the antenna.

The sizes of the main board 100 and the ground area 105 may be limited by the size limitation of the antenna module, and when the antenna is disposed close to the limited ground area 105, the isolation of the antenna may be degraded. However, the embodiment may be provided with the first shunt device 310, thereby improving the isolation of the pair of monopole antennas 210 and 230 adjacent in the limited ground area 105.

In addition, the antenna module according to the embodiment may further include a second shunt device 330 branched from the feeding line and connected in parallel to the first shunt device 310. The second shunt device 330 may be a shunt resistor shunt R that is grounded to the ground. As described above, by providing the parallel resistance in the matching circuit of the antenna, the radiation resistance of the antenna is increased to improve the radiation power interference between the adjacent monopole antennas 210 and 230, thereby improving the isolation of the antenna. In the embodiment, the second shunt device 330 may be connected in parallel with the first shunt device 310 to further improve the isolation of the monopole antennas 210 and 230.

Preferred embodiments according to the present invention have been described above, and it is obvious to those skilled in the art that the present invention can be embodied in other specific forms without departing from the spirit or scope of the present invention in addition to the above-described embodiments. Therefore, the above-described embodiments are regarded as illustrative rather than restrictive, and accordingly, the present invention is not limited to the above description, but may be modified within the scope of the appended claims and their equivalents.

1: An antenna module comprising:
a ground area formed in a rectangular shape on at least a portion of a main board;
a pair of power feeding units formed at two of edge portions of the rectangular ground area while being spaced apart from each other; and
a pair of monopole antennas electrically connected to the power feeding units, respectively, and disposed on the ground area.

2: The antenna module of claim 1, further comprising a first shunt device branching from a feeding line connected to the monopole antenna from the power feeding unit.

3: The antenna module of claim 2, further comprising a second shunt device branching from the feeding line while being connected in parallel with the first shunt device.

4: The antenna module of claim 1, wherein the power feeding units are formed at both ends of one short side of the rectangular ground area while facing each other.

5: The antenna module of claim 4, wherein one of the pair of monopole antennas is disposed along a long side of the ground area, and a remaining monopole antenna is disposed along a short side of the ground area.

6: The antenna module of claim 4, wherein one of the pair of monopole antennas is disposed along a long side of the ground area, and a remaining monopole antenna is disposed along another long side of the ground area.

7: The antenna module of claim 4, further comprising a global navigation satellite system (GNSS) antenna or a Wi-Fi antenna disposed along a long side of the ground area in adjacent to the monopole antenna disposed along the long side of the ground area.

8: The antenna module of claim 1, wherein the power feeding units are formed at both ends of one long side of the rectangular ground area while facing each other.

9: The antenna module of claim 8, wherein one of the pair of monopole antennas is disposed along a long side of the ground area, and a remaining monopole antenna is disposed along a short side of the ground area.

10: The antenna module of claim 8, wherein one of the pair of monopole antennas is disposed along one short side of the ground area, and a remaining monopole antenna is disposed along another short side of the ground area.

11: The antenna module of claim 8, further comprising a global navigation satellite system (GNSS) antenna or a Wi-Fi antenna disposed along a long side of the ground area between the pair of monopole antennas.

12: A vehicle comprising an antenna module according to claim 1.
